(19) United States
(12) Patent Application Publication
(10) Pub. No.: US 2024/0046324 A1
(43) Pub. Date: Feb. 8, 2024

(54) DIGITAL TOKEN GENERATION AND OUTPUT FOR RIDERS OF AUTONOMOUS VEHICLES

(71) Applicant: GM Cruise Holdings LLC, San Francisco, CA (US)

(72) Inventors: Jennifer McKnew, San Francisco, CA (US); Benjamin Ashman, San Francisco, CA (US); Rogerio Oddone, San Rafael, CA (US); Roxanna Aliaga, San Francisco, CA (US)

(73) Assignee: GM Cruise Holdings LLC, San Francisco, CA (US)

(21) Appl. No.: 17/879,772

(22) Filed: Aug. 3, 2022

(51) Int. Cl. G06Q 30/02; G05D 1/00; G06Q 50/30; G01C 21/34

(52) U.S. Cl. CPC G06Q 30/0282; G05D 1/0088; G06Q 50/30; G01C 21/343; G01C 21/3469

(57) ABSTRACT

Sensors on autonomous vehicles offer data that can be used to track and recognize rider achievement. Digital tokens can be output to users on a user device to provide feedback to the user in real-time. To determine an appropriate digital token, data specific to the user can be matched against a template or checked against a threshold. A digital token corresponding to a matched template or a crossed threshold can be then retrieved or generated. In some cases, the data specific to the user is used to determine whether the user matches a pattern. A user can accrue a collection of digital tokens on the user device.

### TECHNICAL FIELD

The present disclosure relates generally to autonomous vehicles, and more particularly, to generating and outputting digital tokens for riders of autonomous vehicles.

### BACKGROUND

Autonomous vehicles (AVs), also known as self-driving cars, driverless vehicles, and robotic vehicles, may be vehicles that use multiple sensors to sense the environment and move without human input. Technology in the AVs may enable the vehicles to drive on roadways and to accurately and quickly perceive the vehicle's environment, including obstacles, signs, and traffic lights.

Much of the operation of the autonomous vehicle occur autonomously, and end users do not typically have visibility into its operation. Also, the sensors of the autonomous vehicle generate a voluminous amount of data that is impossible for end users to comprehend. This means that end users of services provided by AVs do not receive feedback from the operation or service, and it can be difficult for users to understand or appreciate the impact of rides or trips taken by AVs. Such feedback and appreciation of the operation or service can be important for increasing usage of the services and retention of end users.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 shows a system for generating feedback to a user of ride hail and/or delivery services provided by AVs, according to some embodiments of the disclosure.

FIG. 2 illustrates sensors mounted on or in the autonomous vehicle that can be used to collect data for generating digital tokens, according to some embodiments of the disclosure;

FIG. 3 illustrates autonomous vehicle location data which can be aggregated for generating digital tokens, according to some embodiments of the disclosure;

FIG. 4 illustrates autonomous vehicle path data which can be aggregated for generating digital tokens, according to some embodiments of the disclosure;

FIG. 5 illustrates autonomous vehicle location data and user location data which can be aggregated for generating digital tokens, according to some embodiments of the disclosure;

FIG. 6 illustrates an exemplary digital token displayed on a user device, according to some embodiments of the disclosure;

FIG. 7 illustrates an exemplary animated digital token displayed on a user device, according to some embodiments of the disclosure;

FIG. 8 illustrates an exemplary collection of digital tokens displayed on a user device, according to some embodiments of the disclosure;

FIG. 9 illustrates an exemplary collection of digital tokens, including a digital token that a user is in the process of earning, displayed on a user device, according to some embodiments of the disclosure;

FIG. 10 illustrates an exemplary digital token, which indicates different levels of user achievement, displayed on a user device, according to some embodiments of the disclosure;

FIG. 11 illustrates another exemplary digital token, which indicates different levels of user achievement, displayed on a user device, according to some embodiments of the disclosure;

FIG. 12 is a flow diagram illustrating an exemplary method for generating feedback to a user of ride hail and/or delivery services provided by AVs, according to some embodiments of the disclosure;

FIG. 13 is a flow diagram illustrating another exemplary method for generating feedback to a user of ride hail and/or delivery services provided by AVs, according to some embodiments of the disclosure;

FIG. 14 is a flow diagram illustrating yet another exemplary method for generating feedback to a user of ride hail and/or delivery services provided by AVs, according to some embodiments of the disclosure;

FIG. 15 illustrates an exemplary system environment that can be used to facilitate autonomous vehicle dispatch and operations, according to some embodiments of the disclosure; and

FIG. 16 illustrates an exemplary processor-based system with which some aspects of the subject technology can be implemented.

### DETAILED DESCRIPTION

### Overview

Users of a service can be motivated by having their achievements recognized. Additionally, users love to share their achievements with their friends and family. Leveraging autonomous vehicle technology, several items work in tandem to enable rider achievements to be recognized. For instance, ride hail services provided by AVs can help users get to their destination, celebrate users' achievements along the way, inspire users to continue their positive contributions to the environment, and connect users to the cities they love.

One way to recognize rider achievement (referred to herein more generally as user achievement) is to generate and output feedback to users in the form of digital tokens. Digital tokens are collectable digital assets that can be awarded to riders to celebrate activity, milestones, positive environmental impact contributions, exploration, community, etc. One example of digital tokens are rider badges. Awarding digital tokens can increase user engagement by providing real-time feedback of the operation and impact of the autonomous vehicle and/or services provided by AVs to the end user. Digital tokens can celebrate values and build a sense of community.

For a ride hail service provided by AVs, a user may be awarded a digital token based on a number of factors computed from autonomous vehicle sensor data and other data. The factors can include, e.g., destination, total distance traveled, use of the service during special local or cultural events, etc. When a user receives real-time feedback for milestones achieved through the digital tokens, the user experience of the service can be improved, and awareness of the operation and impact of the autonomous vehicle and/or services provided by the AVs can increase.

In some cases, the digital tokens can serve to inform the user of a noteworthy moment has occurred because of autonomous vehicle technology. For example, a user may not know a threshold of having traveled 10, 20, 50, 100, 500+ miles in an autonomous vehicle has been crossed. Based on real-time sensor data from AVs, the user can be notified or informed of such achievement of crossing a threshold or achieving a milestone. The digital token can be output to the user through an immediate graphical and/or audible experience via an application on a user device, such as a mobile phone or an in-vehicle tablet in an autonomous vehicle. The user can be alerted of the accomplishment achieved.

A user can share the event of earning a digital token with friends and family via social media to increase a sense of community for the user and for others in the community. Users can also view previously earned digital token(s) to give the user a sense of accomplishment and progress.

Digital tokens are not limited to providing feedback on user achievement. Some digital tokens can be used to educate or inform the user of an aspect of the operation of the autonomous vehicle (especially aspects which are not readily apparent or appreciated by a user). For instance, a digital token can be generated and output to the user in response to the autonomous vehicle having made an unprotected left turn without a driver. Such digital tokens can build and increase trust with users.

Sensors on AVs offer data that can be used to track and recognize rider achievement. Digital tokens can be output to users on a user device to provide feedback to the user in real-time. To determine an appropriate digital token, data specific to the user can be matched against a template or checked against a threshold. A digital token corresponding to a matched template or a crossed threshold can be then retrieved or generated. In some cases, the data specific to the user is used to determine whether the user matches a pattern. A user can accrue a collection of digital tokens on the user device.

### Exemplary System for Generating Feedback to a User of Services Provided by AVs

AVs can provide a variety of services, such as ride hailing (including ride sharing), and delivery. Ride hailing allows users to request rides or trips, where the rides/trips are serviced by a fleet of AVs. Delivery allows various users or businesses to load item(s) onto an autonomous vehicle, which will deliver the loaded item(s) to an intended recipient to a specified drop-off location. These services are not encumbered by staffing and scheduling of drivers, and thus can be a viable and attractive alternative to services provided by vehicles requiring a driver.

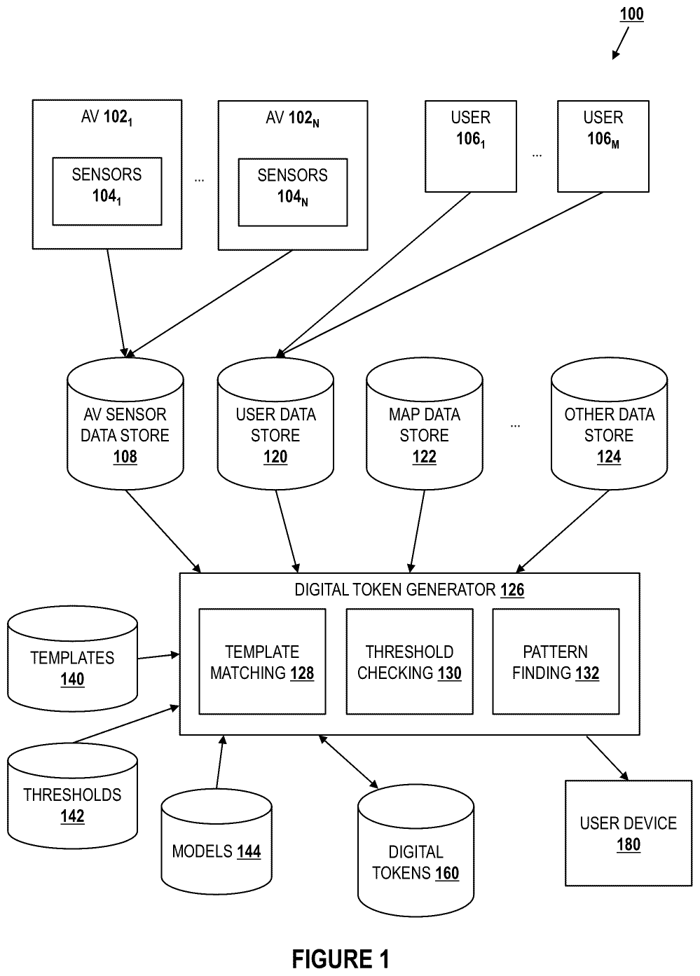

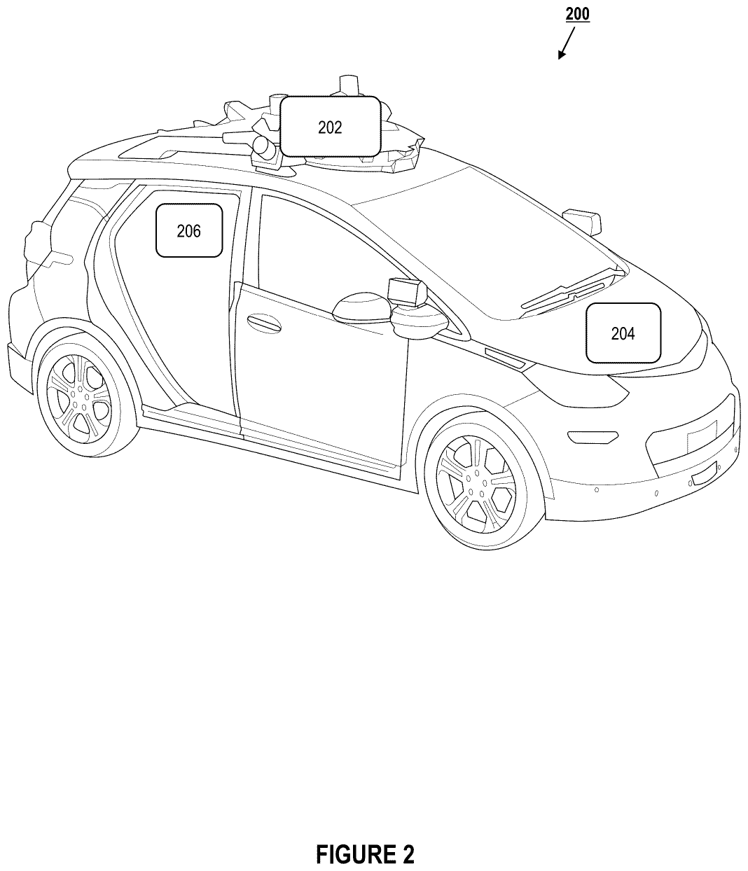

To increase retention and engagement of users to use services provided AVs, feedback can be generated from sensor data collected by AVs. FIG. 1 shows a system 100 for generating feedback to a user of ride hail and/or delivery services provided by AVs, according to some embodiments of the disclosure. The system includes one or more AVs (e.g., N number of depicted as AVs 102₁, . . . 102_{N}), and one or more users (e.g., M number of users depicted as users 106₁, . . . 106_{M}) that are serviced by the one or more AVs. The users 106₁, . . . 106_{M} utilize one or more services provided by AVs 102₁, . . . 102_{N}. As the users 106₁, . . . 106_{M} use one or more services provided by AVs 102₁, . . . 102_{N}, the sensors on the AVs, e.g., sensors 104₁ on AV 102₁, and sensors 104_{N} on AV 102_{N}) collect and generate data, which can be stored in AV sensor data store 108. Sensors on the AVs can generate different kinds of data, which are explained and illustrated in various examples described herein (see e.g., FIG. 2). Users 106₁, . . . 106_{M} may also cause data to be generated or have associated data (e.g., user profile data, user calendar/schedule data, user activity data inside the AVs, user activity data outside of the AV, user activity data that it not associated with the services provided by the AVs, etc.), and the user data may be stored in user data store 120. Other data sources, such as map data (e.g., semantic objects, connected lane graphs, points of interest information, congestion information, geography information, etc.) in map data store 122, and other data (e.g., event data, calendar data, weather data, emergency announcements, government alerts, etc.) in other data store 124 may be used for generating user feedback.

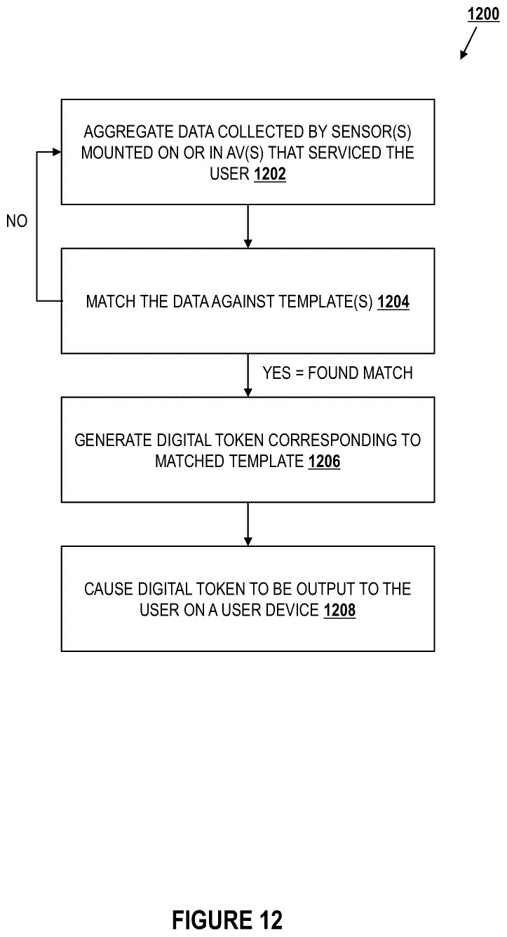

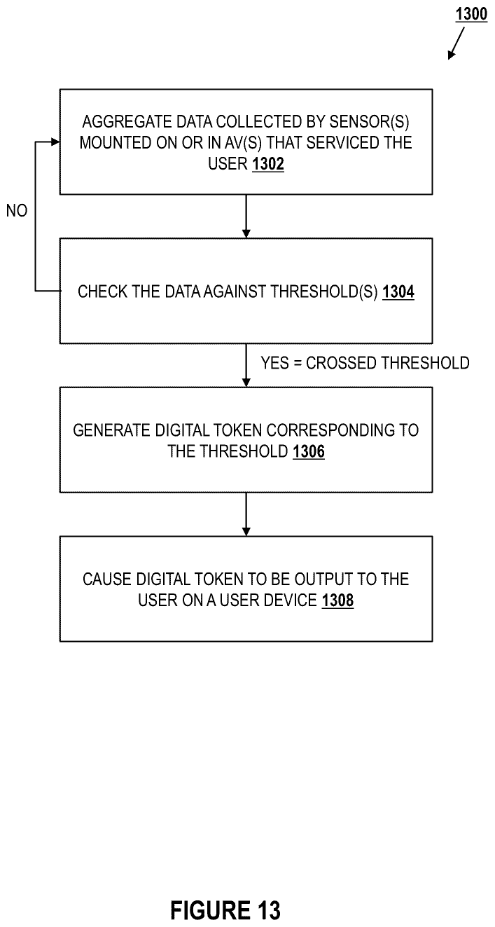

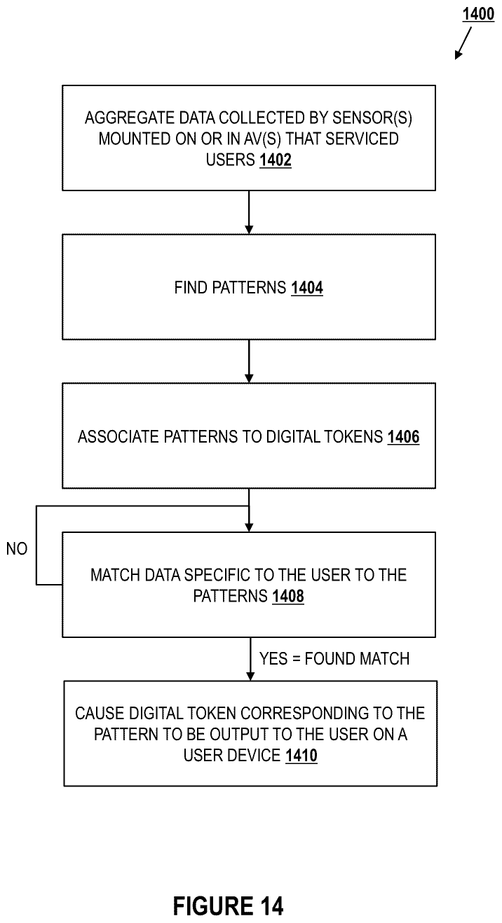

System 100 further includes digital token generator 126 that can implement one or more of the following functions: template matching 128 (illustrated in FIG. 12), threshold checking 130 (illustrated in FIG. 13), and pattern finding 132 (illustrated in FIG. 14). Details of these functions are explained and illustrated in various examples described herein. The digital token generator 126 can access one or more of the following data stores: templates 140, thresholds 142, and models 144. Each template in templates 140 can include one or more conditions or criteria of user achievement. Each threshold in thresholds 142 can be a numerical value indicating different levels of user achievement, e.g., level of user achievement on a scale. Thresholds can be applicable to a selected group of users (i.e., thresholds may be different depending on the user). In some cases, a (personalized or customized) threshold may be set upon analyzing user data (corresponding to a specific user or a group of users) such that a baseline threshold can be determined. A set of thresholds can be determined/set for a given user based on the baseline and offset(s) from the baseline. Each model in models 144 can be a mathematical, logical, and/or a statistical model that can take input(s) (e.g., AV sensor data and other data) and output information that can be used to retrieve and/or generate appropriate digital token(s). Models in models 144 may be learned from past labeled user data. Details of these data stores and the information stored thereon are explained and illustrated in various examples described herein.

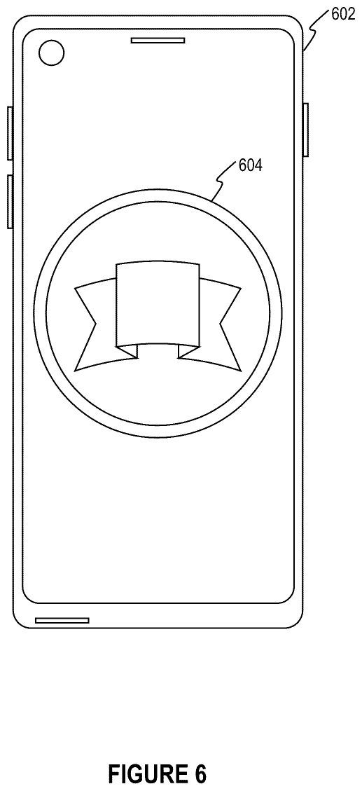

The digital token generator 126 can access or retrieve (previously generated) digital tokens from digital tokens 160. Digital tokens can be in the form of, e.g., a graphic file, an animation file, a video file, or an audio file. The digital token generator 126 can output generated digital tokens to digital tokens 160. Finally, the digital token generator 126 can cause user device 180 to output digital tokens to the user. Details of digital tokens are explained and illustrated in various examples described herein (e.g., examples of digital tokens are illustrated in FIGS. 6-11).

### Exemplary Data Used for Generating Feedback to a User of Services Provided by AVs

AV sensors can collect data that can be used for generating feedback that indicates user achievement. Sensor is used herein broadly to encompass devices which can sense the environment and generate sensor data, and other devices which generate data associated with the AV. Leveraging the sensor data, AVs may be uniquely positioned to offer feedback that are germane to services provided by AVs, and feedback that can enlighten users. In addition, the sensor data may be processed to extract insights into user achievement in ways that have not been considered by other ride hail and/or deliver services. Sensor data can include a variety of data collected before, during, and/or after a ride/trip. Examples of sensor data can include, but are not limited to, location information of rides/trips taken, time-related information of ride/trips taken, user location information, data that indicates to a state of a user, data that indicates a state of an AV, data that indicates a state of the environment of the AV, etc.

FIG. 2 illustrates sensors mounted on or in the autonomous vehicle 200 that can be used to collect data for generating digital tokens, according to some embodiments of the disclosure. Autonomous vehicle 200 may have vehicle sensors 202. Vehicle sensors 202 may include one or more light detection and ranging (LIDAR) sensors, one or more radio detection and ranging (RADAR) sensors, one or more temperature sensors, one or more microphones, one or more capacitive sensors, one or more air pressure sensors, one or more atmospheric pressure sensors, one or more wind sensors, one or more image sensors, one or more global positioning system (GPS) sensors, one or more accelerometers, one or more gyroscopes, one or more vibration sensors, one or more wheel rotation sensors, one or more steering wheel displacement sensors, one or more tire pressure gauge sensors, one or more battery life/health sensors, one or more fuel level sensors, one or more collision/impact sensors, etc.

Vehicle sensors 202 can collect location information of rides/trips taken, e.g., using one or more of: GPS sensors, accelerometers, gyroscopes, speedometer, wheel rotation sensor, and wheel displacement sensors. Location information include geolocation information of various points of a ride/trip. Distance information or displacement information can be derived from location information. Velocity information can be derived from the speedometer. If time-related information is also available, velocity and acceleration information can be derived from location information alone.

Vehicle sensors 202 can collect user location information, e.g., using one or more of: LIDAR sensors, microphones, and image sensors, to sense location of user approaching the AV. Distance information or displacement information can be derived from location information. If time-related information is also available, velocity and acceleration information can be derived from location information alone.

Vehicle sensors 202 can collect data that indicates to a state of a user, e.g., using one or more of: LIDAR sensors, image sensors, and microphones to sense information about a user as the user approaches the AV. The information can include personal data (e.g., height, hair color, etc.) of the user, movement of the user, whether the user is accompanied by other user(s) or pet(s), whether the user is carrying item(s), user sentiment, etc.

Vehicle sensors 202 can collect data that indicates a state of an AV. For instance, different kinds of vehicle sensors 202 can be used to derive comfort level of a ride/trip. In another instance, some vehicle sensors 202 can be used to derive energy consumed (battery power and/or fuel consumption). In yet another instance, vehicle sensors 202 can be used to derive whether the AV experienced a collision or was very close to another object or road user.

Vehicle sensors 202 can collect data that indicates a state of the environment of the AV, etc. For example, RADAR sensors can be used to derive weather (e.g., rain, fog, etc.) surrounding the AV. Temperature sensors can be used to derive temperature of the environment surrounding the AV. Image sensors can be used to derive the lighting conditions of the environment surrounding the AV. One or more of: RADAR sensors, LIDAR sensors, image sensors, and microphones, can be used to sense noise level, congestion level, and/or presence of crowds surrounding the AV. Atmospheric pressure sensors can be used to derive barometric readings of the environment surrounding the AV. Atmospheric pressure sensors can be used to derive barometric readings of the environment surrounding the AV, which can be used as an indicator of weather. Wind sensors can be used to determine amount of wind in the environment surrounding the AV.

Autonomous vehicle 200 may have a computing system 204 that can generate data associated with the state of an AV. The data can be used to generate feedback that indicates user achievement. The computing system 204 may generate data regarding objects perceived by the AV perception stack. The computing device system may generate data regarding maneuvers taken as a result of the operations of the AV planning and AV control stack. The computing system 204 may generate data regarding cabin controls, such as state of the doors, state of the windows, state of the infotainment system, state of the lighting system, state of the in-vehicle tablet, commands to the doors, windows, infotainment system, seat adjustment system, heating setting, ventilation setting, and air conditioning setting. The computing system 204 may generate data regarding utilization of user feature(s) provided in the vehicle (e.g., interaction with an in-vehicle tablet, interaction with cabin controls, etc.). The computing system 204 may generate data regarding errors and resolution of errors (e.g., whether remote intervention was required during a trip/ride). The computing system 204 may generate path data corresponding the intended and/or actual path traversed by an AV.

Autonomous vehicle 200 may have in-vehicle sensors 206. In-vehicle sensors 206 may collect and generate data that indicates to a state of a user, and/or data that indicates a state of an AV. The data can be used to generate feedback that indicates user achievement. In-vehicle sensors 206 may include one or more of image sensors, microphones, one or more of time of flight sensors, one or more of occupancy sensors, one or more of seat sensors, one or more of vital sign monitoring sensors, one or more of temperature sensors, one or more of electronic noses, one or more dust sensors, one or more smoke sensors, one or more of moisture sensors, etc. In-vehicle sensors 206 can sense information about user(s) in the vehicle (e.g., user sentiment, health of users, alertness, gaze, whether a user is asleep or intoxicated, etc.). In-vehicle sensors 206 can sense cleanliness of the vehicle cabin. In-vehicle sensors 206 can sense whether item(s) have been left in the vehicle cabin. In-vehicle sensors 206 can sense presence of noxious or hazardous substances in the vehicle cabin. In-vehicle sensors 206 can sense presence of a pleasant smell in the vehicle cabin. In-vehicle sensors 206 can sense the lack of unpleasant smells in the vehicle cabin.

Various data collected by vehicle sensors 202, computing system 204, and in-vehicle sensors 206, can be aggregated to generate feedback to users utilizing services provided by AVs. By processing the data in unique ways, tangible feedback information can be provided to the user in the form of digital tokens, where the digital tokens can convey user achievement.

It is understood that the above examples of sensor data described in relation to FIG. 2 are not meant to be limiting, but merely illustrate the types of sensor data that can be used for generating digital tokens. The following passages describe several exemplary use cases.

### Exemplary Processing of Vehicle Location Data and User Location Data to Generate Feedback

When a user takes a ride with AV or uses an AV for a delivery, the user may not recognize the impact of using these services, especially how these services compare with alternative services. One type of sensor data that can be used to generate meaningful and tangible feedback comes from the trips/rides that a user has taken with AVs. Specifically, vehicle/user location information, path information, time-related information, and energy consumption information, can offer insights into user achievement, such as the exploration of a neighborhood, utilization of the service during a specific event, repetitiveness of certain rides/trips, etc.

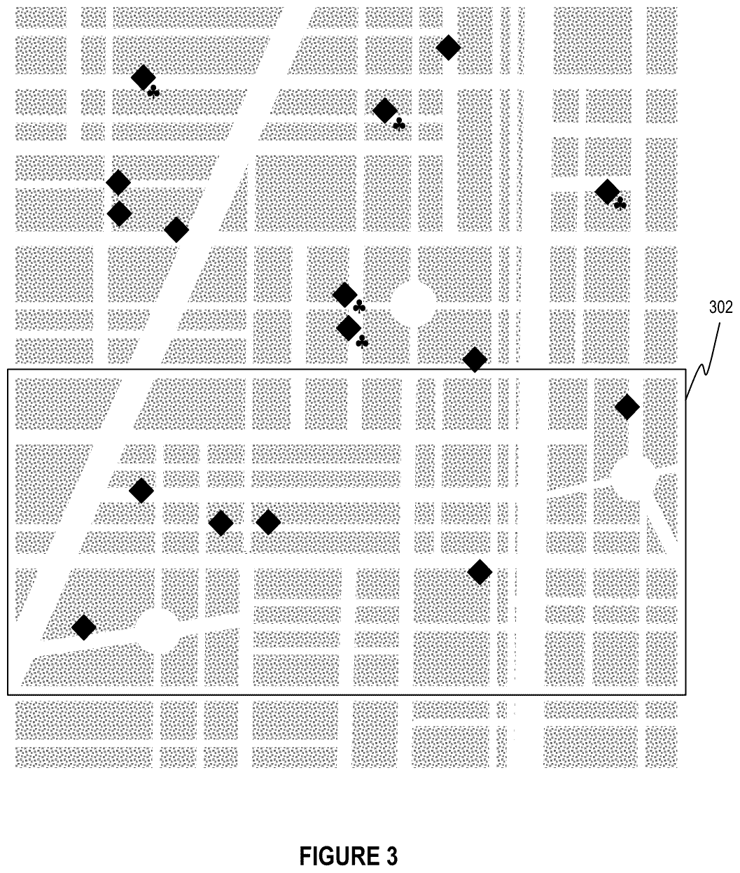

FIG. 3 illustrates autonomous vehicle location data which can be aggregated for generating digital tokens, according to some embodiments of the disclosure. Trips/rides are associated with a starting location (pick-up location or origin) and an ending location (drop-off location or destination). In some cases, trips/rides may include one or more stopping locations (e.g., pit stop during a trip/ride). These locations are shown with the symbol ♦ in the FIGURE, overlaying a geographical map having blocks (shown with a pattern) and roads (shown as blank space between blocks). The location information (e.g., geolocation/coordinates, semantic objects in the vicinity, type of location, etc.) corresponding to these locations can yield feedback to the user, such as an extent of exploration or utilization of an area. The location information can be processed in different ways to extract various kinds of feedback information for the user.

In some examples, the number of locations of the trips/rides taken by AVs that serviced a user in a geographical area (e.g., a block, a neighborhood, etc.) can be checked against a threshold. For illustration, area 302 is shown in the FIGURE. If the number of locations in a given area, e.g., area 302, crosses the threshold, a digital token corresponding to the crossed threshold can be generated as feedback for the user. For instance, if a user has more than 15 locations within a neighborhood (e.g., area 302), then a digital token indicating that the user is the “mayor” of the neighborhood (e.g., area 302) can be generated. There may be multiple thresholds on a scale against which the number of locations within a neighborhood is checked, and different digital tokens may be generated based on the specific threshold that was crossed to indicate different levels of user achievement.

In some examples, the locations can be matched against a template. If the locations matches a template set of locations (e.g., key landmarks on a map, top restaurants of the neighborhood, all museums in the neighborhood, etc.), then a digital token corresponding to the matched template set of locations can be generated as feedback for the user. For illustration, a template set of locations is shown as [symbol] in the FIGURE. For instance, if the user has 5 locations that correspond to 5 historical landmarks specified in a template, then a digital token indicating that the user is the “historian” can be generated. A variety of template set of locations can be defined with corresponding digital tokens that can be generated.

In some examples, the locations can be processed to determine a degree of clustering or a degree of spread. Specifically, the geolocation/coordinates (e.g., x, y coordinates or longitude, latitude coordinates) can be processed to compute variance in different dimensions. A high value for variance can indicate a high degree of spread and a low degree of clustering in a given dimension. If the locations indicate a high degree of spread and a low degree of clustering, a digital token that corresponds to exploration (e.g., “scout”. “explorer”, etc.) can be generated and output to a user. A low value for variance can indicate a low degree of spread and a high degree of clustering in a given dimension. If the locations indicate a low degree of spread and a high degree of clustering, a digital token that corresponds to loyalty to a specific area determined by a central point of the cluster, such as mean coordinates) can be generated and output to a user.

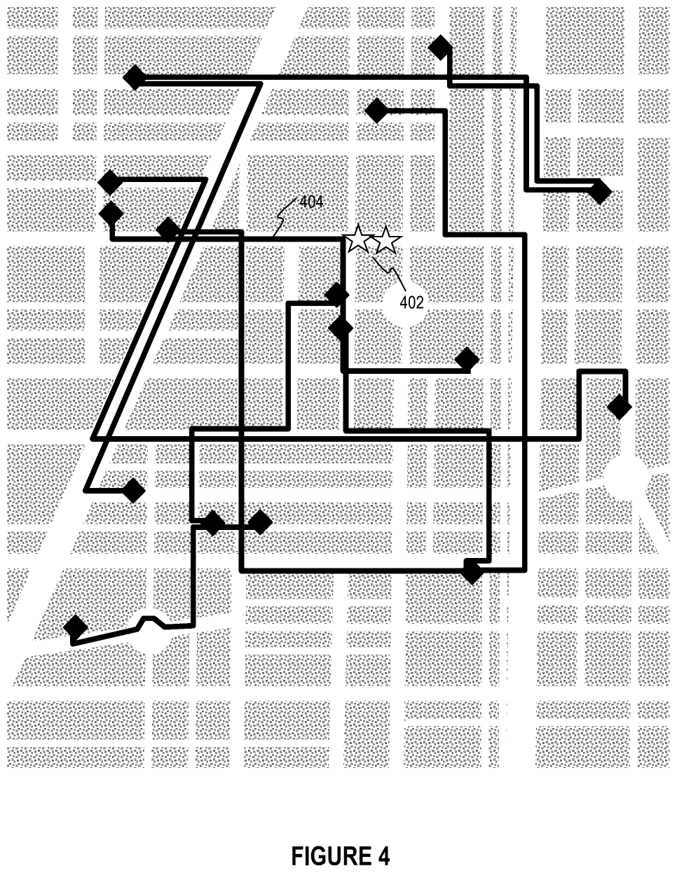

FIG. 4 illustrates autonomous vehicle path data which can be aggregated for generating digital tokens, according to some embodiments of the disclosure. Paths are illustrated as lines connecting locations shown with the symbol ♦ in the FIGURE overlaying a geographical map having blocks (shown with a pattern) and roads (shown as blank space between blocks). As the user utilizes AVs for trips/rides, path data can be collected by AV sensors, e.g., in the form of paths traversed in a connected graph (the connected graph representing connected lanes/roads of a map). Path data can be generated based on vehicle location data and/or path data from the computing system of the AV before, during, and/or after one or more trips/rides taken by the AV(s) that serviced a user. Path data can also include geolocation/coordinates of where the AV has been (i.e., various points in a path), distance traveled, etc. Besides location information, other sensor data (e.g., as illustrated in FIG. 2) corresponding to various paths can also be collected and processed to generate the feedback to the user.

In some examples, the path data in the form of paths traversed in a connected graph can be measured for coverage in the connected graph in different ways. For instance, the number of vertices in the paths traversed in the connected graph relative to the total number of vertices in the connected graph can be compared against a threshold to assess how well the paths cover the connected graph. In another instance, the number of edges in the paths traversed in the connected graph relative to the total number of edges in the connected graph can be compared against a threshold to assess how well the paths cover the connected graph. Amount of coverage of the graph crossing a threshold can trigger generating digital tokens that indicate a level or extent of exploration.

In some examples, the path data define areas traveled by the AV. The size of the areas relative to the total traversable area of a neighborhood can be compared against a threshold to assess how well the paths cover the neighborhood. The areas traveled by the AV crossing a threshold can trigger generating digital tokens that indicate a level or extent of exploration.

In some examples, the path data can be matched against a template to determine whether the paths have come near or crossed one or more specified points of interest, e.g., the path was near a parade, or passed by street gathering. The points of interest defined by the template may be permanent (i.e., having no temporal component) or occurs during a specific period of time (i.e., having a temporal component). An exemplary point of interest having a temporal component such as an outdoor cultural festival 402 is shown in the FIGURE. One of the paths, path 404, was near the festival 402 at the same time the festival 402 was held. Paths, e.g., path 404, matching a template can trigger generating digital tokens that provides user feedback on utilization of the AV services during a specific community event.

In some examples, the path data define distance traveled. Cumulative distance traveled for the paths can yield tangible feedback to the user. Distance traveled can be compared against a threshold or a thresholds on a scale. Crossing one or more thresholds for distance traveled can trigger generating digital tokens that indicate a level of utilization of AV service (e.g., reaching an X miles milestone of distance traveled). The digital tokens corresponding to different thresholds on a scale may progressively indicate an increase in the level of user achievement, as the user crosses higher and higher thresholds.

In some examples, the path data have corresponding amounts of energy consumed. Energy consumed can be indirectly derived from the distance traveled by the paths (and potentially other data from the AV), or directly derived from AV sensors (e.g., battery life, fuel consumed, etc.). Path data, such as energy consumption, can be processed, e.g., compared against a threshold, to generate feedback on environmental impact for the user utilizing the AV services, especially if the AVs are electric vehicles that have less emissions than the gas vehicle counterparts. Path data, such as distance traveled, can be used, using data on relative amounts of emissions between electric vehicles and gas vehicles per mile. Energy consumption of an electric AV can have an equivalent amount of emissions avoided relative to its gas AV counterparts. Path data that indicates energy consumption crossing one or more thresholds may trigger generating digital tokens that indicate the environmental impact of using services provided by electric AVs as opposed to gas vehicles.

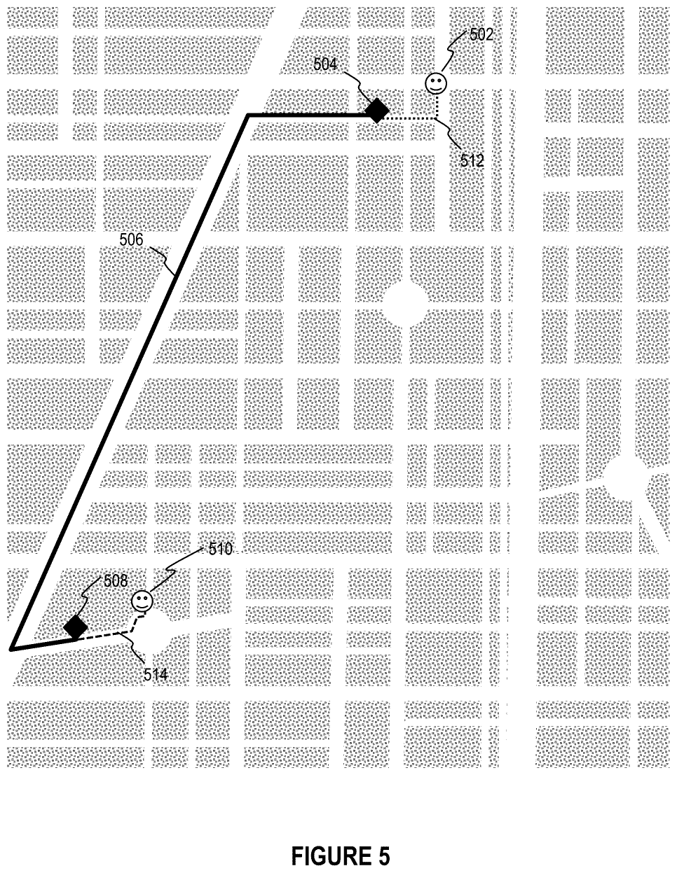

FIG. 5 illustrates autonomous vehicle location data and user location data which can be aggregated for generating digital tokens, according to some embodiments of the disclosure. As the user utilizes AVs for trips/rides, path data can be collected by AV sensors, based on vehicle location data, path data from the computing system of the AV, and user location data, collected before, during, and/or after one or more trips taken by the one or more AVs that serviced the user. For illustration, one path of an exemplary trip/ride using an AV is shown in the FIGURE as a line 506 connecting a starting location 504 and an ending location 508 overlaying a geographical map having blocks (shown with a pattern) and roads (shown as blank space between blocks). Additionally, for illustration, one walking path 512 of a user walking towards the starting location 504 and another walking path 514 of the user walking away from the ending location 504 to reach the final destination are shown in the FIGURE. Walking path 512 and walking path 514 can be generated based on user location data collected before, during, and/or after one or more trips taken by the one or more AVs that serviced the user.

In some examples, path data associated with walking path 512 and walking path 514 can be processed in a similar way as the AV paths illustrated in FIG. 4.

In some examples, path data associated with walking path 512 and walking path 514 defines distance walked by the user. Cumulative distance walked can yield tangible feedback to the user. Distance walked can be compared against a threshold or a thresholds on a scale. Crossing one or more thresholds for distance traveled can trigger generating digital tokens that indicate a level of ecofriendly or healthy user behavior. The digital tokens corresponding to different thresholds on a scale may progressively indicate an increase in the level of ecofriendly or healthy user behavior, as the user crosses higher and higher thresholds.

### Exemplary Digital Tokens and User Devices Outputting Digital Tokens

Besides collecting salient AV sensor data, appropriate digital tokens are retrieved and/or generated for the user to convey tangible information about the user's achievement and experience with the services provided by AVs. Digital tokens can be output to the user via one or more modalities through one or more user devices, the modalities can include one or more of, e.g., visual (e.g., as a graphic or animation), textual (e.g., outputting a message), audio (e.g., as an audio clip), and haptic (e.g., vibrations of the user device). Some digital tokens take the form of a static graphic, while some other digital tokens can take the form of an animation or movie graphic. Some digital tokens can be personalized to the user with user-specific data and information. Additionally, some other digital tokens can be retrieved and/or generated to convey progress (e.g., progression over time, or change over time) towards different levels of user achievement.

FIG. 6 illustrates an exemplary digital token 604 displayed on a user device 602, according to some embodiments of the disclosure. As an example, user device 602 may be a mobile electronic device with one or more output devices (e.g., display, speaker, haptic actuator, etc.). The user device 602 may be the user's mobile phone, or an in-vehicle tablet of the AV. Preferably, the user device 602 runs an application which can output digital token(s) to the user. Digital token 604 is represented by a graphic in this example, and is provided as feedback to the user in the form of a rider badge.

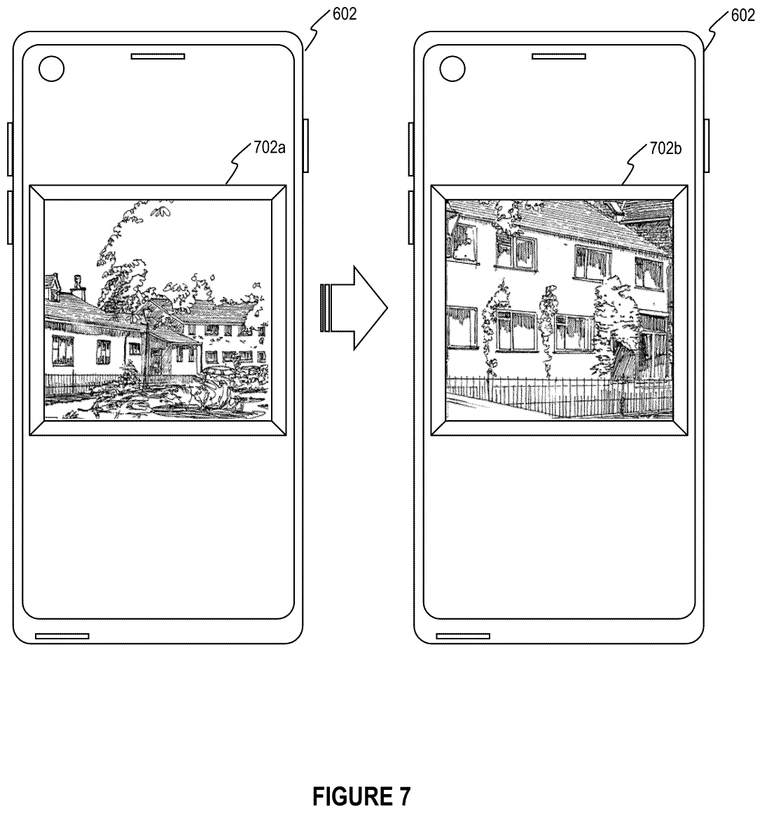

FIG. 7 illustrates an exemplary animated digital token, illustrated as digital token frame 702a and digital token frame 702b, displayed on a user device 602, according to some embodiments of the disclosure. In some cases, the digital token may be animated/collated to output/display a plurality of frames (e.g., such as digital token frame 702a and digital token frame 702b) in sequence. In this particular example, the digital token frame 702a and digital token frame 702b may be generated using AV sensor data collected during one or more trips/rides that a user has taken. In some cases, selected image or video data captured of the cabin of an AV that serviced the user can be used for the animated digital token. In some cases, selected image or video data captured of the surroundings of an AV that serviced the user can be used for the animated digital token. Salient image or video data may be selected to match the user achievement that the digital token aimed to convey. Additionally, because the image or video data is collected while the user is being serviced by the AV, the resulting digital token is highly personalized to the user and the user's experience. For instance, if AV sensor data suggests the user has met conditions of being a “historian” for having visited a specific set of historical landmarks, the image or video data of the historical landmarks captured by the AV sensors while the AV(s) are servicing the user can be used to generate the digital token.

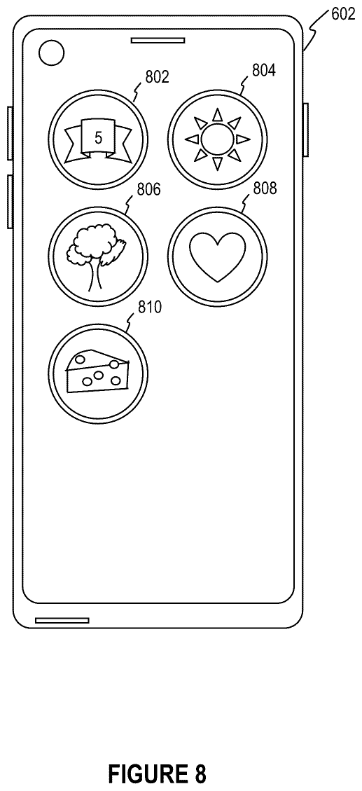

FIG. 8 illustrates an exemplary collection of digital tokens displayed on a user device, according to some embodiments of the disclosure. The exemplary collection shows different digital tokens: digital token 802, digital token 804, digital token 806, digital token 808, and digital token 810. The different digital tokens can convey different levels or kinds of user achievement. When a collection of digital tokens is displayed to a user, the user can appreciate and celebrate a diversity of user achievements.

Digital token 802 may celebrate a mileage milestone, upon determining from the sensor data that the distance traveled in AVs has surpassed 5 miles.

Digital token 804 may convey a recognition that the user has taken a lot of rides in the morning, upon determining from the sensor data and other data that that the user has utilize the AV service in the morning 20 times.

Digital token 806 may convey a recognition that the user is an ecofriendly user, upon determining from the sensor data that that the user has kept the windows of the AV opened, and not used the air conditioner during three rides on three days with outside temperature of above 90 degrees Fahrenheit.

Digital token 808 may convey a recognition that the user celebrated Valentine's day, upon detecting from the sensor data and other data that the user took a ride with a significant other, carried flowers, and stopped at a restaurant on a trip on Valentine's day.

Digital token 810 may convey an achievement milestone of the user's experience with the service provided by AVs. Many AVs, without unique names, can be fungible. This means that a user may not readily appreciate the different AVs that the user has experienced (e.g., ridden in, or seen on the road), or even the number of AVs that the user has experienced. To assist in providing meaningful user feedback, the AVs that are providing a service to the user may have unique names, such as different names of cheeses, different names of fish species, different names of breakfast food, or different names of characters in a movie. Some unique names have themes or are part of a collection. The names of the AVs a user has ridden in can be collected as part of or along with AV sensor data. Names of AVs that the user has seen or passed by on the road can also be sensed with AV sensors (e.g., camera data) and collected as part of or along with AV sensor data. Based on the name(s) collected, the digital token 810 may be generated based on unique names or themes of names associated AVs that the user has ridden in or the AVs have seen on the road. Such names or themes of names can be leveraged as feedback to the user in the form of digital token 810 to make their experience with AVs more tangible or easier to appreciate. The collected name(s) of AVs can be checked against a condition (e.g., check if this AV name is in the historical list of names of AVs the user has taken a ride in or have been exposed to), or a pattern (e.g., check if all AVs in a collection or belonging to a particular theme are present in the historical list of names of AVs the user has taken a ride in or have been exposed to). In some cases, when a user takes a ride in an AV whose name does not appear in a historical list of names, the digital token 810 can represent the name of the AV. This digital token can contribute towards a personal collection of digital tokens representing all the names of the AVs that the user has taken a ride with historically. Besides keeping track of historical progress, the collection of digital tokens can encourage the user to progress towards riding more AVs that the user has not yet experienced. In some cases, when a user takes a ride in an AV whose name appears in a collection of names having the same theme, the digital token 810 can represent the theme. In some cases, when a user experiences AVs whose names complete a collection of names having the same theme, the user may receive a digital token 810 that represents the theme.

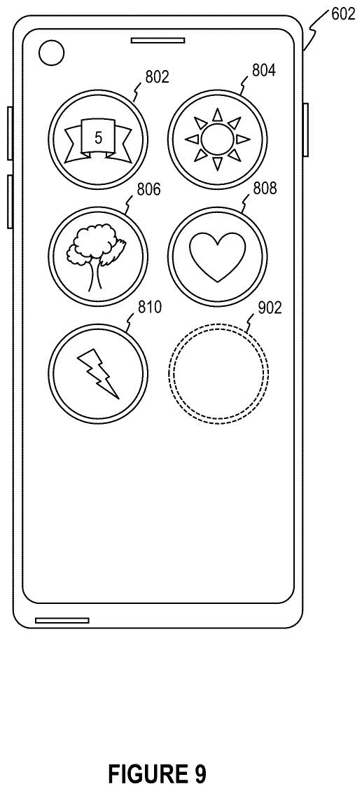

FIG. 9 illustrates an exemplary collection of digital tokens, including a digital token 902 that a user is in the process of earning or has partially earned, displayed on a user device, according to some embodiments of the disclosure. Digital token 902 is displayed to the user with dashed lines or may have reduced opacity. Opacity or faintness of the digital token 902 may indicate to the user that the sensor data associated with the user has not yet been found to match a specific template, to cross a specific threshold, or to match a pattern. However, the sensor data may partially match a specific template, be sufficiently close to the specific threshold, or partially match a pattern. Digital token 902 may indicate to the user that the user is in progress to earning a digital token. A digital token like digital token 902 not only can provide real-time feedback, the progress to earning the digital token can also be conveyed in real-time. As a result, the user may be encouraged or motivated to fully earn the digital token by utilizing the AV services more.

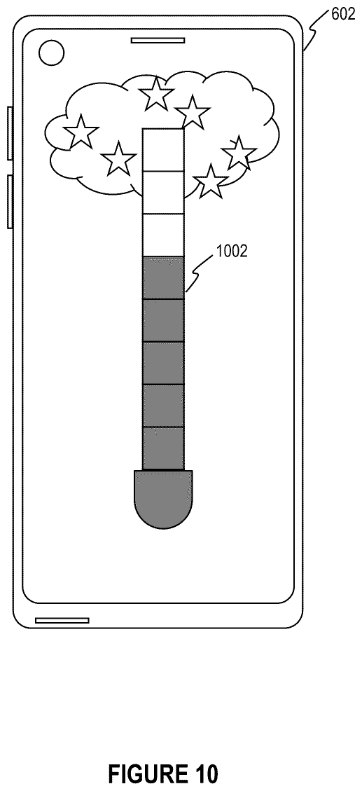

FIG. 10 illustrates an exemplary digital token 1002, which indicates different levels of user achievement, displayed on a user device, according to some embodiments of the disclosure. In some cases, the different levels of user achievement is defined by thresholds on a scale. As the sensor data is found to cross one or more thresholds, a digital token in the form of a thermometer or marked ruler can be generated to allow the user to visually see and assess the level of user achievement. In this example, depending on the crossed threshold, the digital token 1002 may display more or less of the marked areas colored with a highlight color to indicate the level of user achievement on a scale.

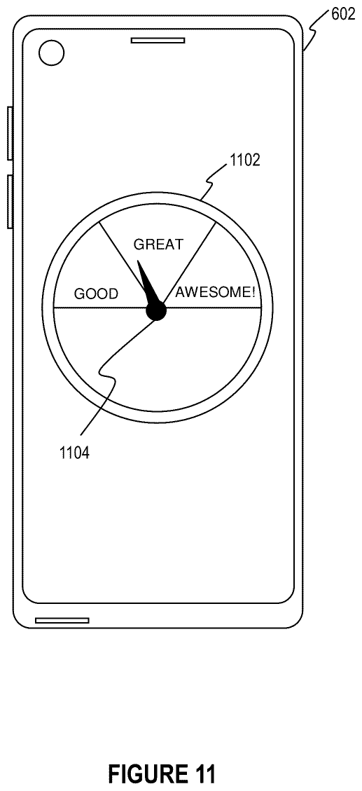

FIG. 11 illustrates another exemplary digital token 1102, which indicates different levels of user achievement, displayed on a user device, according to some embodiments of the disclosure. In some cases, the different levels/categories of user achievement is defined by thresholds on a scale. As the sensor data is found to cross one or more thresholds, a digital token in the form of a meter or gauge can be generated to allow the user to visually see and assess the level of user achievement. In this example, depending on the crossed threshold, the digital token 1002 may change the position of a pointer 1104 in the meter/gauge graphic to indicate the level of user achievement on a scale.

### Other Output Generated in Response to Various Triggers

In place of or in addition to outputting digital token(s) to a user via a user device, real-world, physical feedback indicating user achievement can be delivered to a user. For instance, upon meeting a trigger (e.g., template match, threshold crossing, and/or pattern match, physical assets corresponding to the trigger can be delivered to the user via the services provided by AVs. In some cases, a physical gift that corresponds to a digital token that the user has just earned can be placed in an AV scheduled to provide a service to the user. For instance, a fruit basket can be placed in an AV scheduled to pick up the user in response to data the user having experienced all AVs bearing fruit names.

In place of or in addition to outputting digital token(s) to a user via a user device, digital rewards such as vouchers or coupons can be generated in response to a user earning a digital token. For instance, a user can receive a discounted or free AV ride for having earned a “500^{th} ride” digital token. The digital rewards would be stored in the user's profile information.

### Other Illustrative Examples of Data That is Processed, Trigger that Causes a Digital Token to Be Generated, and Digital Token

| | Exemplary Trigger | |
|---|---|---|
| Exemplary AV Sensor Data | (Template Match, | |
| and Optionally Other Data | Threshold Crossing, and/or | Exemplary Digital |
| of Trips/Rides Taken by the | Pattern Match) for | Token(s) Indicating |
| User | Generating a Digital Token | User Achievement |
| Time-related information of | Number of times the AV did | A clock graphic indicating |
| AV waiting for the user to | not wait for more than 2 | that the user is timely |
| arrive at starting location of a | minutes exceeding a threshold | |
| trip/ride (pick-up point) | | |
| Driving mode of AV | Number of miles the AV was | A tree graphic indicating the |
| trips/rides (eco mode, energy | in eco driving mode (or other | user is ecofriendly |
| saving mode, scenic mode, | modes) exceeding a threshold | |
| aggressive driving mode, | | |
| cautious driving mode, no left | | |
| turns mode, fast mode, slow | | |
| mode, etc.) | | |
| Driving maneuvers, images of | AV made an unprotected left | A video of the surroundings of |
| the AV surroundings | turn, AV yielded to a cyclist, | the AV as captured by the |
| | or AV yielded to an | vehicle cameras showing the |
| | unexpected jaywalker | difficult maneuver to the user |
| Heating setting, ventilation | AV air conditioning was not | A graphic displaying the |
| setting, air conditioning | on during a trip/ride when the | energy saved for not having |
| setting, window setting, | outside temperature was | air conditioning on during the |
| temperature sensor data, | above 90 degrees Fahrenheit | trip/ride |
| images of the AV | and there was no cloudy skies | |
| surroundings, | | |
| weather/atmospheric sensor | | |
| data | | |
| Image data and/or audio data | AV interior cabin stayed clean | A graphic conveying |
| captured of an interior vehicle | after the trip by comparing | sparkling cleanliness and a |
| cabin before, during, and/or | pictures of the interior cabin | message thanking the user for |
| after trips/rides | before and after the trip/ride | keeping AVs clean |
| Image data and/or audio data | Paths corresponding to | An animated graphic showing |
| captured of a surrounding | trips/rides taken by the user | frames of image data and/or |
| environment before, during, | meet a sufficient coverage | audio of the neighborhood and |
| and/or after trips/rides | metric of a neighborhood | a crown for the user being the |
| | | king/queen of the |
| | | neighborhood |
| Image data, audio data, and/or | An AV trip/ride taken in | A graphic conveying an AV |
| sensor data, of a surrounding | foggy conditions | navigating through a cloud, to |
| environment before, during, | | recognize that the AV helped |
| and/or after trips/rides | | the user arrive at the |
| | | destination in spite of difficult |
| | | weather conditions |
| Time-related information, | The AV passing by a street | A graphic displaying an image |
| image data, audio data, and/or | festival during a trip/ride | captured of the street festival, |
| sensor data, of a surrounding | | audio clip of the street festival, |
| environment before, during, | | and a message informing the |
| and/or after trips/rides | | user information about the |
| | | street festival |
| Time-related information | A number of trips taken | A graphic conveying a |
| (e.g., duration information, | between the hours of 3 pm to | worker, for recognizing the |
| time of day, month, holiday, | 7 pm (rush hour) exceeding a | user being a super commuter |
| day of the week, day of the | threshold | |
| month, special events, | | |
| associated with trips/rides) | | |
| Vehicle feature usage by user | All features used by user | A graphic conveying that the |
| and/or user engagement | | user is a “Pro User” of the AV |
| during trips/rides | | service and the AV itself |
| Distance traveled on | Distance traveled crossing one | A graphic that indicates |
| trips/rides | of a plurality of thresholds on | meeting or crossing the |
| | a scale | crossed threshold among other |
| | | thresholds on the scale |
| Battery life consumed on | Cumulative amount of battery | A graph that indicates the user |
| trips/rides | life used on trips/rides | meeting or crossing a crossed |
| | exceeding a threshold among | threshold among other |
| | a plurality of thresholds on a | thresholds displayed in the |
| | scale | graphic indicating different |
| | | levels of carbon emissions |
| | | avoided |
| Data from computing system | User assisted a nearby AV by | A rider badge graphic that |
| on AV | providing instructions through | indicates the user is a helper of |
| | the computing system of the | the AV community and lend a |
| | AV to the nearby AV to help | helping hand to others |
| | the nearby AV maneuver out | |
| | of a difficult situation | |
| Image data collected by AV | User was detected from the | A rider badge graphic that |
| | image data that the user | indicates the user is a helper of |
| | assisted another passenger in | the AV community and lend a |
| | getting in/out of the AV | helping hand to others |

### Exemplary Methods for Generating Feedback to a User of Services Provided by AVs

FIG. 12 is a flow diagram illustrating an exemplary method 1200 for generating feedback to a user of ride hail and/or delivery services provided by AVs, according to some embodiments of the disclosure. The method 1200 can be implemented by digital token generator 126 as seen in FIGS. 1, 15, and 16. In 1202, data collected by one or more sensors mounted on or in one or more AVs that serviced the user is aggregated. Exemplary sensor data is illustrated in FIG. 2. In 1204, the data is matched against one or more templates, wherein the templates define one or more conditions or criteria of user achievement. In 1206, a digital token corresponding to a matched template is generated. If no match is found, then the method 1200 returns to 1202. In 1208, a digital token is caused to be output to the user on a user device. Examples of digital tokens are illustrated in FIGS. 6-11.

FIG. 13 is a flow diagram illustrating another exemplary method 1300 for generating feedback to a user of ride hail and/or delivery services provided by AVs, according to some embodiments of the disclosure. The method 1300 can be implemented by digital token generator 126 as seen in FIGS. 1, 15, and 16. In 1302, data collected by one or more sensors mounted on or in one or more AVs that serviced the user is aggregated. Exemplary sensor data is illustrated in FIG. 2. In 1304, the data is checked against one or more thresholds, wherein the thresholds are numerical values indicating levels of user achievement. In 1306, in response to the data crossing a threshold, a digital token corresponding to the crossed threshold is generated. If no threshold is crossed, then the method 1300 returns to 1302. In 1308, a digital token is caused to be output to the user on a user device. Examples of digital tokens are illustrated in FIGS. 6-11.

FIG. 14 is a flow diagram illustrating yet another exemplary method 1400 for generating feedback to a user of ride hail and/or delivery services provided by AVs, according to some embodiments of the disclosure. The method 1400 can be implemented by digital token generator 126 as seen in FIGS. 1, 15, and 16. In 1402, data collected by one or more sensors mounted on or in one or more AVs that serviced a plurality of users is aggregated. Exemplary sensor data is illustrated in FIG. 2. In 1404, different patterns are found based on the aggregated data. For instance, patterns can be learned from past data. Patterns can be defined by templates and/or thresholds. In 1406, the different patterns are associated to different digital tokens. For instance, the digital tokens can convey different forms or levels of user achievement corresponding to the different patterns. In 1408, the data specific to the user (as collected through trips/rides that the user took with the AV service) is matched to the different patterns. In 1410, in response to the data matching a pattern, a digital token corresponding to the pattern is caused to be output to the user on a user device. Examples of digital tokens are illustrated in FIGS. 6-11. If no match is found, then the method returns to 1408.

In some cases, patterns can be found in 1404 through unsupervised learning. For instance, finding the different patterns can be done through clustering, such as k-means clustering. Clustering can be performed on the aggregated data to identify a plurality of classes of users (i.e., different patterns). Then, defining characteristics associated with each class of users can be determined (e.g., finding a center point of each cluster/class and using the center point to define the defining characteristics of each cluster class). The defining characteristics of the classes of users can be linked to the different patterns. The resulting patterns (and the corresponding defining characteristics) can be applied as templates where data specific to a user can be matched against the conditions/criteria of the template (i.e., by determining whether the data sufficiently meets the defining characteristics).

In some cases, patterns can be found in 1404 through supervised learning, if a labeled data set of user data to different classes of users is available. Finding different patterns can include training a model using labeled data that associates data collected by the one or more sensors to different classes of users. Matching the data specific to the user can include providing the data specific to the user as input to the trained model and observing an output of the trained model. The trained model can output probabilities of the user being in each one of the classes of users. Depending on the design of the model, classes of users may be template-based, and/or threshold-based. Models can be stored in models 144 of FIG. 1.

### Other Systems for Generating Feedback to a User of Services Provided by AVs

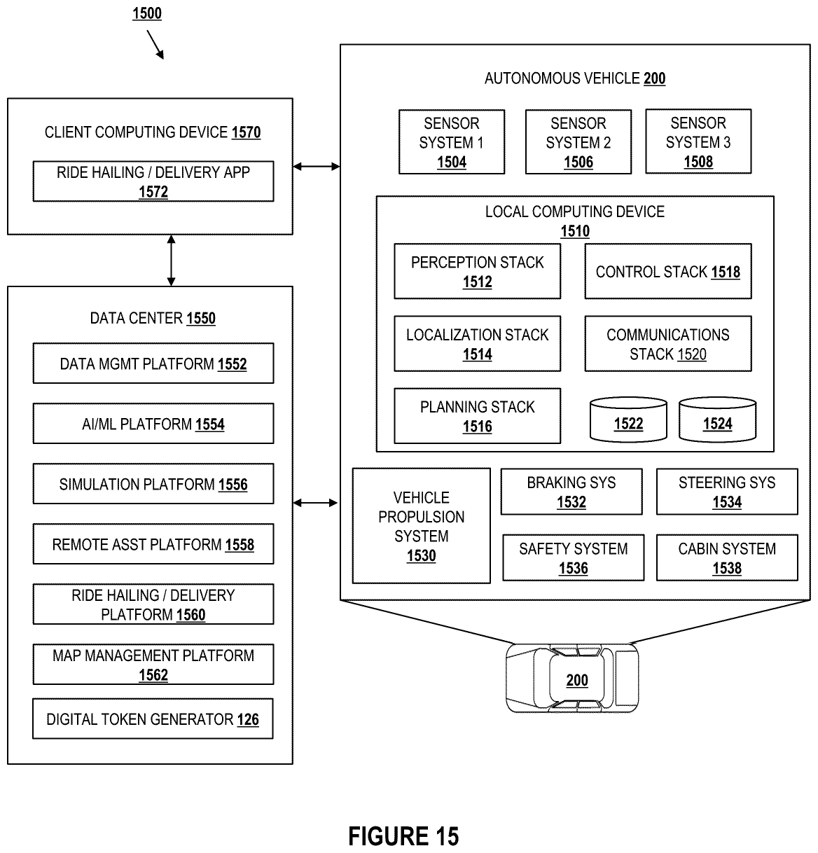

FIG. 15 illustrates an exemplary AV management system 1500 environment that can be used to facilitate autonomous vehicle dispatch and operations in providing AV-enabled services, according to some embodiments of the disclosure. In this example, the AV management system 1500 includes an AV 200, a data center 1550, and a client computing device 1570 (which can correspond to user device 180). The AV 200, the data center 1550, and the client computing device 1570 can communicate with one another over one or more networks (not shown).

AV 200 can navigate about roadways without a human driver based on sensor signals generated by multiple sensor systems 1504, 1506, and 1508. The sensor systems 1504-1508 can include different types of sensors and can be arranged about the AV 200. For instance, the sensor systems 1504-1508 can comprise IMUs, cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., GPS receivers), audio sensors (e.g., microphones, SONAR systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 1504 can be a camera system, the sensor system 1506 can be a LIDAR system, and the sensor system 1508 can be a RADAR system. Other embodiments may include any other number and type of sensors. The sensor systems 1504-1508 can be used in a similar fashion as the sensors described in FIG. 2 to collect data that can be used for generating feedback to users.

AV 200 can also include several mechanical systems that can be used to maneuver or operate AV 200. For instance, the mechanical systems can include vehicle propulsion system 1530, braking system 1532, steering system 1534, safety system 1536, and cabin system 1538, among other systems. Vehicle propulsion system 1530 can include an electric motor, an internal combustion engine, or both. The braking system 1532 can include an engine brake, a wheel braking system (e.g., a disc braking system that utilizes brake pads), hydraulics, actuators, and/or any other suitable componentry configured to assist in decelerating AV 200. The steering system 1534 can include suitable componentry configured to control the direction of movement of the AV 200 during navigation. Safety system 1536 can include lights and signal indicators, a parking brake, airbags, and so forth. The cabin system 1538 can include cabin temperature control systems, in-cabin entertainment systems, and so forth. In some embodiments, the AV 200 may not include human driver actuators (e.g., steering wheel, handbrake, foot brake pedal, foot accelerator pedal, turn signal lever, window wipers, etc.) for controlling the AV 200. Instead, the cabin system 1538 can include one or more client interfaces (e.g., Graphical User Interfaces (GUIs), Voice User Interfaces (VUIs), etc.) for controlling certain aspects of the mechanical systems 1530-1538. Data relating to the mechanical systems can be used for generating feedback to users.

AV 200 can additionally include a local computing device 1510 (corresponding to computing system 204 in FIG. 2) that is in communication with the sensor systems 1504-1508, the mechanical systems 1530-1538, the data center 1550, and the client computing device 1570, among other systems. The local computing device 1510 can include one or more processors and memory, including instructions that can be executed by the one or more processors. The instructions can make up one or more software stacks or components responsible for controlling the AV 200; communicating with the data center 1550, the client computing device 1570, and other systems; receiving inputs from riders, passengers, and other entities within the AV's environment; logging metrics collected by the sensor systems 1504-1508; and so forth. In this example, the local computing device 1510 includes a perception stack 1512, a mapping and localization stack 1514, a planning stack 1516, a control stack 1518, a communications stack 1520, a High Definition (HD) geospatial database 1522, and an AV operational database 1524, among other stacks and systems.

Perception stack 1512 can enable the AV 200 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 1504-1508, the mapping and localization stack 1514, the HD geospatial database 1522, other components of the AV, and other data sources (e.g., the data center 1550, the client computing device 1570, third-party data sources, etc.). The perception stack 1512 can detect and classify objects and determine their current and predicted locations, speeds, directions, and the like. In addition, the perception stack 1512 can determine the free space around the AV 200 (e.g., to maintain a safe distance from other objects, change lanes, park the AV, etc.). The perception stack 1512 can also identify environmental uncertainties, such as where to look for moving objects, flag areas that may be obscured or blocked from view, and so forth.

Mapping and localization stack 1514 can determine the AV's position and orientation (pose) using different methods from multiple systems (e.g., GPS, IMUs, cameras, LIDAR, RADAR, ultrasonic sensors, the HD geospatial database 1522, etc.). For example, in some embodiments, the AV 200 can compare sensor data captured in real-time by the sensor systems 1504-1508 to data in the HD geospatial database 1522 to determine its precise (e.g., accurate to the order of a few centimeters or less) position and orientation. The AV 200 can focus its search based on sensor data from one or more first sensor systems (e.g., GPS) by matching sensor data from one or more second sensor systems (e.g., LIDAR). If the mapping and localization information from one system is unavailable, the AV 200 can use mapping and localization information from a redundant system and/or from remote data sources.

The planning stack 1516 can determine how to maneuver or operate the AV 200 safely and efficiently in its environment. Planning stack 1516 can generate and output path data and/or driving maneuver data of the AV 200. For example, the planning stack 1516 can receive the location, speed, and direction of the AV 200, geospatial data, data regarding objects sharing the road with the AV 200 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 200 from one point to another. The planning stack 1516 can determine multiple sets of one or more mechanical operations that the AV 200 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 1516 can select from multiple backup plans to carry out. For example, while preparing to change lanes to turn right at an intersection, another vehicle may aggressively cut into the destination lane, making the lane change unsafe. The planning stack 1516 could have already determined an alternative plan for such an event, and upon its occurrence, help to direct the AV 200 to go around the block instead of blocking a current lane while waiting for an opening to change lanes.

The control stack 1818 can manage the operation of the vehicle propulsion system 1830, the braking system 1632, the steering system 1534, the safety system 1536, and the cabin system 1538. The control stack 1518 can receive sensor signals from the sensor systems 1504-1508 as well as communicate with other stacks or components of the local computing device 1510 or a remote system (e.g., the data center 1550) to effectuate operation of the AV 200. For example, the control stack 1518 can implement the final path or actions from the multiple paths or actions provided by the planning stack 1516. This can involve turning the routes and decisions from the planning stack 1516 into commands for the actuators that control the AV' s steering, throttle, brake, and drive unit.

The communication stack 1520 can transmit and receive signals between the various stacks and other components of the AV 200 and between the AV 200, the data center 1550, the client computing device 1570, and other remote systems. The communication stack 1520 can enable the local computing device 1510 to exchange information remotely over a network.

The HD geospatial database 1522 can store HD maps and related data of the streets upon which the AV 200 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes. Similar types of map data can be stored in map data store 122 of FIG. 1 for enabling digital token generation.

The AV operational database 1524 can store raw AV data generated by the sensor systems 1504-1508 and other components of the AV 200 and/or data received by the AV 200 from remote systems (e.g., the data center 1550, the client computing device 1570, etc.). In some embodiments, the raw AV data can include HD LIDAR point-cloud data, image or video data, RADAR data, GPS data, and other sensor data that the data center 1550 can use for creating or updating AV geospatial data. In some examples, the data center 1550 can include user profiles.

The data center 1550 can be a private cloud (e.g., an enterprise network, a co-location provider network, etc.), a public cloud, a hybrid cloud, a multi-cloud, and so forth. The data center 1550 can include one or more computing devices remote to the local computing device 1510 for managing a fleet of AVs and AV-related services. For example, in addition to managing the AV 200, the data center 1550 may also support a ride hailing service, a delivery service, a remote/roadside assistance service, street services (e.g., street mapping, street patrol, street cleaning, street metering, parking reservation, etc.), and the like.

The data center 1550 can send and receive various signals to and from the AV 200 and the client computing device 1570. These signals can include sensor data captured by the sensor systems 1504-1508, roadside assistance requests, software updates, ride hailing/delivery pick-up and drop-off instructions, and so forth. In this example, the data center 1505 includes one or more of a data management platform 1552, an Artificial Intelligence/Machine Learning (AI/ML) platform 1554, a simulation platform 1556, a remote assistance platform 1558, a ride hailing/delivery platform 1560, and a map management platform 1562, among other systems.

Data management platform 1552 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ride hailing/delivery service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 1550 can access data stored by the data management platform 1552 to provide their respective services.

The AI/ML platform 1554 can provide the infrastructure for training and evaluating machine learning algorithms for operating the AV 200, the simulation platform 1556, the remote assistance platform 1558, the ride hailing/delivery platform 1560, the map management platform 1562, digital token generator 126, and other platforms and systems. Using the AI/ML platform 1554, data scientists can prepare data sets from the data management platform 1552; select, design, and train machine learning models; evaluate, refine, and deploy the models; maintain, monitor, and retrain the models; and so on. For example, patterns can be learned using AI/ML platform 1554 (in ways described in relation to FIG. 14).

The simulation platform 1556 can enable testing and validation of the algorithms, machine learning models, neural networks, and other development efforts for the AV 200, the remote assistance platform 1558, the ride hailing/delivery platform 1560, the map management platform 1562, and other platforms and systems. The simulation platform 1556 can replicate a variety of driving environments and/or reproduce real-world scenarios from data captured by the AV 200, including rendering geospatial information and road infrastructure (e.g., streets, lanes, crosswalks, traffic lights, stop signs, etc.) obtained from the map management platform 1562; modeling the behavior of other vehicles, bicycles, pedestrians, and other dynamic elements; simulating inclement weather conditions, different traffic scenarios; and so on.

The remote assistance platform 1558 can generate and transmit instructions regarding the operation of the AV 200. For example, in response to an output of the AI/ML platform 1554 or other system of the data center 1505, the remote assistance platform 1558 can prepare instructions for one or more stacks or other components of the AV 200.

The ride hailing/delivery platform 1560 can interact with a customer of a ride hailing/delivery service via a ride hailing/delivery application 1572 executing on the client computing device 1570. The client computing device 1570 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general-purpose computing device for accessing the ride hailing/delivery application 1572. The client computing device 1570 can be a customer's mobile computing device, an in-vehicle mobile computing device or a computing device integrated with the AV 200 (e.g., the local computing device 1510). The ride hailing/delivery platform 1560 can receive requests to be picked up or dropped off from the ride hailing/delivery application 1572 and dispatch the AV 200 for the trip. The ride hailing/delivery application 1572 may output digital tokens to users in manners described in the present disclosure.

Map management platform 1562 can provide a set of tools for the manipulation and management of geographic and spatial (geospatial) and related attribute data. The data management platform 1552 can receive LIDAR point-cloud data, image data (e.g., still image, video, etc.), RADAR data, GPS data, and other sensor data (e.g., raw data) from one or more AVs 1502, Unmanned Aerial Vehicles (UAVs), satellites, third-party mapping services, and other sources of geospatially referenced data. The raw data can be processed, and map management platform 1562 can render base representations (e.g., tiles (2D), bounding volumes (3D), etc.) of the AV geospatial data to enable users to view, query, label, edit, and otherwise interact with the data. Map management platform 1562 can manage workflows and tasks for operating on the AV geospatial data. Map management platform 1562 can control access to the AV geospatial data, including granting or limiting access to the AV geospatial data based on user-based, role-based, group-based, task-based, and other attribute-based access control mechanisms. Map management platform 1562 can provide version control for the AV geospatial data, such as to track specific changes that (human or machine) map editors have made to the data and to revert changes when necessary. Map management platform 1562 can administer release management of the AV geospatial data, including distributing suitable iterations of the data to different users, computing devices, AVs, and other consumers of HD maps. Map management platform 1562 can provide analytics regarding the AV geospatial data and related data, such as to generate insights relating to the throughput and quality of mapping tasks.

In some embodiments, the map viewing services of map management platform 1562 can be modularized and deployed as part of one or more of the platforms and systems of the data center 1505. For example, the AI/ML platform 1554 may incorporate the map viewing services for visualizing the effectiveness of various object detection or object classification models, the simulation platform 1556 may incorporate the map viewing services for recreating and visualizing certain driving scenarios, the remote assistance platform 1558 may incorporate the map viewing services for replaying traffic incidents to facilitate and coordinate aid, the ride hailing/delivery platform 1560 may incorporate the map viewing services into the ride hailing/delivery application 1572 to enable passengers to view the AV 200 in transit en route to a pick-up or drop-off location, and so on.

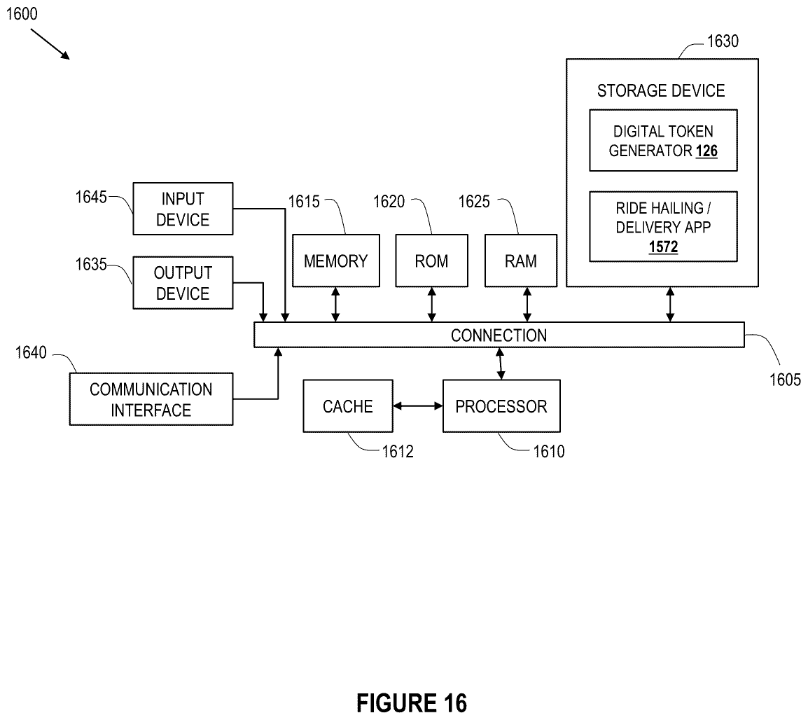

FIG. 16 illustrates an exemplary processor-based system with which some aspects of the subject technology (e.g., methods illustrated in FIGS. 12-14) can be implemented. For example, processor-based system 1600 can be any computing device making up, or any component thereof in which the components of the system are in communication with each other using connection 1605. Connection 1605 can be a physical connection via a bus, or a direct connection into processor 1610, such as in a chipset architecture. Connection 1605 can also be a virtual connection, networked connection, or logical connection.

In some embodiments, computing system 1600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Exemplary system 1600 includes at least one processing unit (Central Processing Unit (CPU) or processor) 1610 and connection 1605 that couples various system components including system memory 1615, such as Read-Only Memory (ROM) 1620 and Random-Access Memory (RAM) 1625 to processor 1610. Computing system 1600 can include a cache of high-speed memory 1612 connected directly with, in close proximity to, or integrated as part of processor 1610.

Processor 1610 can include any general-purpose processor and a hardware service or software service, such as digital token generator 126, and ride hailing/delivery application 1572 stored in storage device 1630, configured to control processor 1610 as well as a special-purpose processor where software instructions are incorporated into the actual processor design. Processor 1610 may essentially be a completely self-contained computing system, containing multiple cores or processors, a bus, memory controller, cache, etc. A multi-core processor may be symmetric or asymmetric.

To enable user interaction, computing system 1600 includes an input device 1645, which can represent any number of input mechanisms, such as a microphone for speech, a touch-sensitive screen for gesture or graphical input, keyboard, mouse, motion input, speech, etc. Computing system 1600 can also include output device 1635, which can be one or more of a number of output mechanisms known to those of skill in the art. Output device 1635 may be used to output digital token(s) to a user of the computing system 1600. In some instances, multimodal systems can enable a user to provide multiple types of input/output to communicate with computing system 1600. Computing system 1600 can include communications interface 1640, which can generally govern and manage the user input and system output. The communication interface may perform or facilitate receipt and/or transmission wired or wireless communications via wired and/or wireless transceivers.

Communication interface 1640 may also include one or more GNSS receivers or transceivers that are used to determine a location of the computing system 1600 based on receipt of one or more signals from one or more satellites associated with one or more GNSS systems. There is no restriction on operating on any particular hardware arrangement, and therefore the basic features here may easily be substituted for improved hardware or firmware arrangements as they are developed.

Storage device 1630 can be a non-volatile and/or non-transitory and/or computer-readable memory device and can be a hard disk or other types of computer-readable media which can store data that are accessible by a computer.

Storage device 1630 can include software services, servers, services, etc., that when the code that defines such software is executed by the processor 1610, it causes the system 1600 to perform a function. In some embodiments, a hardware service that performs a particular function can include the software component stored in a computer-readable medium in connection with the necessary hardware components, such as processor 1610, connection 1605, output device 1635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general-purpose or special-purpose computer, including the functional design of any special-purpose processor as described above. By way of example, and not limitation, such tangible computer-readable devices can include storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### Select Examples

Example 1 is a method for generating feedback to a user of ride hail and/or delivery services provided by autonomous vehicles, the method comprising: aggregating data collected by one or more sensors mounted on or in one or more autonomous vehicles that serviced the user; matching the data against one or more templates, wherein the templates define one or more conditions or criteria of user achievement; generating a digital token corresponding to a matched template; and causing a digital token to be output to the user on a user device.

In Example 2, the method of Example 1 can optionally include the data collected by the one or more sensors comprising one or more of: starting location, stopping location, and ending location, of one or more trips taken by the one or more autonomous vehicles that serviced the user.

In Example 3, the method of Example 1 or 2 can optionally include the data collected by the one or more sensors comprising one or more paths traversed in a connected graph; and the one or more paths corresponding to one or more trips taken by the one or more autonomous vehicles that serviced the user.

In Example 4, the method of any one of Examples 1-3 can optionally include the data collected by the one or more sensors comprising distance traveled for one or more trips taken by the one or more autonomous vehicles that serviced the user.

In Example 5, the method of any one of Examples 1-4 can optionally include the data collected by the one or more sensors comprising energy consumed for one or more trips taken by the one or more autonomous vehicles that serviced the user.

In Example 6, the method of any one of Examples 1-5 can optionally include the data collected by the one or more sensors comprising location of the user before, during, and/or after one or more trips taken by the one or more autonomous vehicles that serviced the user.

In Example 7, the method of any one of Examples 1-6 can optionally include, wherein the data collected by the one or more sensors comprises driving mode for one or more trips taken by the one or more autonomous vehicles that serviced the user.

In Example 8, the method of any one of Examples 1-7 can optionally include the data collected by the one or more sensors comprising driving maneuvers for one or more trips taken by the one or more autonomous vehicles that serviced the user.

In Example 9, the method of any one of Examples 1-8 can optionally include the data collected by the one or more sensors comprising one or more of: heating setting, ventilation setting, and/or air conditioning setting for one or more trips taken by the one or more autonomous vehicles that serviced the user.

In Example 10, the method of any one of Examples 1-9 can optionally include the data collected by the one or more sensors comprising image data and/or audio data captured of an interior vehicle cabin before, during, and/or after one or more trips taken by the one or more autonomous vehicles that serviced the user.

In Example 11, the method of any one of Examples 1-10 can optionally include the data collected by the one or more sensors comprising image data and/or audio data captured of a surrounding environment before, during, and/or after one or more trips taken by the one or more autonomous vehicles that serviced the user.

In Example 12, the method of any one of Examples 1-11 can optionally include the data collected by the one or more sensors comprising one or more: image data, audio data, and/or sensor data, of a surrounding environment during one or more trips taken by the one or more autonomous vehicles that serviced the user.

In Example 13, the method of any one of Examples 1-12 can optionally include the data collected by the one or more sensors comprising time-related information associated with one or more trips taken by the one or more autonomous vehicles that serviced the user.

In Example 14, the method of any one of Examples 1-13 can optionally include the data collected by the one or more sensors comprising vehicle feature usage and/or engagement during one or more trips taken by the one or more autonomous vehicles that serviced the user.

In Example 15, the method of any one of Examples 1-14 can optionally include matching the data against the one or more templates comprising further matching other data that is not collected by the one or more sensors against the one or more templates.

In Example 16, the method of any one of Examples 1-15 can optionally include matching the data against the one or more templates comprises determining whether the data meets the one or more conditions or criteria of user achievement.

In Example 17, the method of any one of Examples 1-16 can optionally include generating the digital token comprising generating an animation using the data; and the digital token being personalized to the user.

In Example 18, the method of any one of Examples 1-17 can optionally include generating the digital token comprising retrieving a graphic file and/or audio file representing the user achievement.

Example 19 is a method for generating feedback to a user of ride hail and/or delivery services provided by autonomous vehicles, the method comprising: aggregating data collected by one or more sensors mounted on or in one or more autonomous vehicles that serviced the user; checking the data against one or more thresholds, wherein the thresholds are numerical values indicating levels of user achievement; in response to the data crossing a threshold, generating a digital token corresponding to the crossed threshold; and causing a digital token to be output to the user on a user device.

In Example 19a, the method of Example 19 can optionally include any one of Examples 2-14, and 17-18.

In Example 20, the method of Example 19 or 19a can optionally include: the one or more thresholds including a plurality of thresholds represented on a scale.

In Example 21, the method of any one of Examples 19, 19a, and 20 can optionally include generating the digital token comprising: generating a graphic that indicates meeting or crossing the crossed threshold among other thresholds.

In Example 22, the method of any one of Examples 19, 19a, and 20-21 can optionally include generating the digital token comprising: generating a graphic that (1) illustrates a plurality of thresholds indicating different levels of user achievement, the plurality of thresholds including the crossed threshold, and (2) indicates the user meeting or crossing the crossed threshold.

In Example 23, the method of any one of Examples 19, 19a, and 20-22 can optionally include analyzing the data to set a baseline; and setting the one or more thresholds based on the baseline and offset(s) from the baseline.

Example 24 is a method for generating feedback to a user of ride hail and/or delivery services provided by autonomous vehicles, the method comprising: aggregating data collected by one or more sensors mounted on or in one or more autonomous vehicles that serviced a plurality of users; finding different patterns based on the aggregated data; associating the different patterns to different digital tokens; matching data specific to the user to the different patterns; in response to the data matching a pattern, causing a digital token corresponding to the pattern to be output to the user on a user device.

In Example 24a, the method of Example 24 can optionally include any one of Examples 2-14, and 17-18.

In Example 25, the method of Example 24 or 24 a can optionally include finding the different patterns comprising: performing clustering on the aggregated data to identify a plurality of classes of users; determining defining characteristics associated with each class of users; and linking the defining characteristics of the classes of users to the different patterns.

In Example 26, the method of any one of Examples 24, 24a, and 25 can optionally include: finding different patterns comprises training a model using labeled data that associates data collected by the one or more sensors to different classes of users; and matching the data specific to the user comprises providing the data specific to the user as input to the trained model and observing an output of the trained model.

In Example 27, the method of any one of Examples 24, 24a, and 25-26 can optionally include the patterns corresponding to different templates, and the templates defining one or more conditions or criteria of user achievement.

In Example 28, the method of any one of Examples 24, 24a, and 25-26 can optionally include the patterns correspond to different thresholds, and thresholds are numerical values indicating levels of user achievement.

In Example 29, the method of any one of Examples 24, 24a, and 25-28 the patterns correspond to different thresholds, and thresholds are numerical values indicating levels of user achievement on a scale.

Example A is an apparatus comprising means to carry out or implement any one of Examples 1-29 (inclusive of 19a and 24a).

Example B is one or more non-transitory computer-readable medium comprising instructions, when the instructions are executed by one or more processors, the instructions cause the one or more processors to carry out or implement any one of Examples 1-29 (inclusive of 19a and 24a).

What is claimed is:

1. A method for generating feedback to a user of ride hail and/or delivery services provided by autonomous vehicles, the method comprising:
aggregating data collected by one or more sensors mounted on or in one or more autonomous vehicles that serviced the user;
matching the data against one or more templates, wherein the templates define one or more conditions or criteria of user achievement;
generating a digital token corresponding to a matched template; and
causing a digital token to be output to the user on a user device.

2. The method of claim 1, wherein the data collected by the one or more sensors comprises one or more of: starting location, stopping location, and ending location, of one or more trips taken by the one or more autonomous vehicles that serviced the user.

3. The method of claim 1, wherein:
the data collected by the one or more sensors comprises one or more paths traversed in a connected graph; and
the one or more paths correspond to one or more trips taken by the one or more autonomous vehicles that serviced the user.

4. The method of claim 1, wherein the data collected by the one or more sensors comprises distance traveled for one or more trips taken by the one or more autonomous vehicles that serviced the user.

5. The method of claim 1, wherein the data collected by the one or more sensors comprises energy consumed for one or more trips taken by the one or more autonomous vehicles that serviced the user.

6. The method of claim 1, wherein matching the data against the one or more templates comprises further matching other data that is not collected by the one or more sensors along with the data against the one or more templates.

7. The method of claim 1, wherein matching the data against the one or more templates comprises determining whether the data meets the one or more conditions or criteria of user achievement.

8. The method of claim 1, wherein:
generating the digital token comprises generating an animation using the data; and
the digital token is personalized to the user.

9. The method of claim 1, wherein generating the digital token comprises retrieving a graphic file and/or audio file representing the user achievement.

10. A method for generating feedback to a user of ride hail and/or delivery services provided by autonomous vehicles, the method comprising:
aggregating data collected by one or more sensors mounted on or in one or more autonomous vehicles that serviced the user;
checking the data against one or more thresholds, wherein the thresholds are numerical values indicating levels of user achievement;
in response to the data crossing a threshold, generating a digital token corresponding to the crossed threshold; and
causing a digital token to be output to the user on a user device.

11. The method of claim 10, wherein:
the one or more thresholds includes a plurality of thresholds represented on a scale.

12. The method of claim 10, wherein generating the digital token comprises:
generating a graphic that indicates meeting or crossing the crossed threshold among other thresholds.

13. The method of claim 10, wherein generating the digital token comprises:
generating a graphic that (1) illustrates a plurality of thresholds indicating different levels of user achievement, the plurality of thresholds including the crossed threshold, and (2) indicates the user meeting or crossing the crossed threshold.

14. The method of claim 10, further comprising:
analyzing the data to set a baseline; and
the one or more thresholds are set based on the baseline and offset(s) from the baseline.

15. A method for generating feedback to a user of ride hail and/or delivery services provided by autonomous vehicles, the method comprising:
aggregating data collected by one or more sensors mounted on or in one or more autonomous vehicles that serviced a plurality of users;
finding different patterns based on the aggregated data;
associating the different patterns to different digital tokens;
matching data specific to the user to the different patterns; and
in response to the data matching a pattern, causing a digital token corresponding to the pattern to be output to the user on a user device.

16. The method of claim 15, wherein finding the different patterns comprises:
performing clustering on the aggregated data to identify a plurality of classes of users;
determining defining characteristics associated with each class of users; and
linking the defining characteristics of the classes of users to the different patterns.

17. The method of claim 15, wherein
finding different patterns comprises training a model using labeled data that associates data collected by the one or more sensors to different classes of users; and
matching the data specific to the user comprises providing the data specific to the user as input to the trained model and observing an output of the trained model.

18. The method of claim 15, wherein the patterns correspond to different templates, and the templates define one or more conditions or criteria of user achievement.

19. The method of claim 15, wherein the patterns correspond to different thresholds, and thresholds are numerical values indicating levels of user achievement.

20. The method of claim 15, wherein the patterns correspond to different thresholds, and thresholds are numerical values indicating levels of user achievement on a scale.
